(19) United States
(12) Patent Application Publication
(10) Pub. No.: US 2003/0165078 A1
(43) Pub. Date: Sep. 4, 2003

(54) Mixer and method for mixing liquids or a solid and a liquid

(76) Inventor: Rakesh Kumar Aggarwal, Victoria (AU)

Correspondence Address: FINNEGAN, HENDERSON, FARABOW, GARRETT & DUNNER, LLP, 1300 I STREET, NW, WASHINGTON, DC, 20005, US

(21) Appl. No.: 10/275,396

(22) PCT Filed: May 2, 2001
(86) PCT No.: PCT/AU01/00494

(30) Foreign Application Priority Data
May 5, 2000 (AU) PQ 7353
Jul. 25, 2000 (AU) PQ 8990

(51) Int. Cl. B01F 15/02

(52) U.S. Cl. 366/136; 366/165.1

(57) ABSTRACT

A mixer for mixing a solid or an additional liquid into a liquid within a mixing vessel using a vortex action obviates direct application of the introduced solid or liquid with the downstream end of the vortex by bending the axis of rotation of the vortex. In one form this is effected by laterally offsetting a discharge outlet of the mixing vessel relative to the upper end portion of the vessel into which the liquid is introduced. The vortex within the vessel is maintained at a predetermined level by applying a static head to the liquid in the vessel. This is preferably achieved by maintaining a predetermined static head of mixture in an outer vessel into which the mixing vessel discharges.

This invention relates to a mixer and a method for mixing liquids, or for mixing a solid and a liquid. More particularly, the invention relates to forming a vortex in a liquid and mixing in an additional liquid or solid by feeding the additional liquid or solid into the vortex.

It is known to establish a vortex in a mixing vessel by introducing liquid into the vessel in a tangential flow path. An additional liquid or solid may then be fed onto a wall of the vortex so as to be mixed with the liquid. A resultant mixed solution may then be extracted from the vessel via an outlet port. Previously proposed mixing vessels for this purpose are of a symmetrical construction such that the vortex is central and concentric relative to the vessel. A disadvantage of such a vessel is that in some circumstances the additional liquid or solid may be inadvertently fed directly to an apex of the vortex, where mixing is impaired due to a build-up of excessive liquid or solid.

Previously proposed mixers of this type also have difficulties in achieving stability of the vortex particularly if the mixer is being used to handle a range of different throughput rates and viscosities of mixture.

In accordance with one aspect of the present invention there is provided a mixer for mixing either a solid or an additional liquid into a liquid, the mixer including means for generating a vortex in said liquid within a mixing vessel, and means for introducing the solid or the additional liquid to the vortex, wherein the mixing vessel is shaped such that the solid or additional liquid is unable to be directly applied to a downstream end of the vortex.

Advantageously, the vessel is shaped so that the downstream end of the vortex is displaced transversely relative to a centre of rotation of the upstream end of the vortex. In practice this displacement may be achieved by “bending” the axis of rotation of the vortex.

Advantageously, the mixing vessel is at least partially within an outer vessel, and the outer vessel extends above and is in fluid communication with an outlet of the mixing vessel, such that the level of liquid in the mixing vessel is dependent on the level of liquid in the outer vessel.

In accordance with another aspect of the present invention there is provided a mixer for mixing either a solid or an additional liquid into a liquid, the mixer including means for generating a vortex in said liquid within a mixing vessel, and means for introducing the solid or the additional liquid to the vortex, wherein the mixing vessel is at least partially within an outer vessel, and the outer vessel extends above and is in fluid communication with an outlet of the mixing vessel, such that the level of liquid in the mixing vessel is dependent on the level of liquid in the outer vessel.

Advantageously, the outer vessel includes baffle means to prevent direct passage from the outlet of the mixing vessel to an outlet of the outer vessel. Particularly advantageously, the baffle means is such as to induce an upwards flow of liquid within the outer vessel whereby air within the mixture discharged from the outlet of the mixing vessel can rise to the surface of the liquid in the outer vessel for dispersal. In a preferred embodiment of the invention, the baffle means comprises a substantially cylindrical sleeve within a lower portion of the outer vessel and surrounding the outlet end portion of the mixing vessel.

The solid or the additional liquid is preferably introduced to the vortex sufficiently close to a perimeter of the vortex such that the occurrence of the solid or the additional liquid falling directly into a central portion of the vortex is minimised.

In one form of the invention, the mixing vessel is shaped such that the outlet thereof is eccentric relative to an upper end of the mixing vessel containing an upstream end of the vortex.

In a preferred embodiment liquid is withdrawn from the outer vessel by pump means for recirculation to the mixing vessel and/or for discharge.

Preferably, the outer vessel is provided with level sensing means for determining the level of liquid, solution or suspension in the outer vessel, and the level sensing means controls a valve in an inlet line for controlling infeed of liquid to the mixing vessel.

When the liquid is mixed with a solid, preferably, the solid is in particulate form and is introduced to the vortex in a stream, for example by an auger feeder.

Preferably, the vortex is controlled such that an inner core of the vortex does not reach the outlet of the mixing vessel.

In accordance with another aspect of the invention, there is provided a mixer for mixing either a solid or an additional liquid into a liquid, the mixer including means for generating a vortex in said liquid within a mixing vessel, means for introducing the solid or the additional liquid to the vortex, and means for providing a static head of said liquid communicating with the liquid in the mixing vessel to maintain a predetermined level of said liquid in the mixing vessel.

In one form, the static head of liquid is determined by the liquid head within an outer vessel into which the outlet from the mixing vessel discharges.

In another form, the static head is determined by the liquid head in an external vessel coupled to the mixing vessel by a liquid feed line.

In accordance with another aspect of the invention, there is provided a mixer for mixing either a solid or an additional liquid into a liquid, the mixer including means for generating a vortex in said liquid within a mixing vessel, and means for introducing the solid or the additional liquid to the vortex, wherein the mixing vessel has at an upper end a large diameter portion which leads via a transition zone into a lower cylindrical portion of substantially reduced diameter.

Advantageously, the large diameter portion at the upper end of the mixing vessel is cylindrical and the transition zone is of frusto conical form.

In another aspect of the present invention there is provided a method for mixing either a solid or an additional liquid into a liquid, including the steps of:

generating a vortex in said liquid within a mixing vessel; and

introducing the solid or the additional liquid to the vortex;

wherein the mixing vessel is shaped such that the solid or additional liquid is unable to be directly applied to a downstream end of the vortex.

Preferably, the downstream end is displaced transversely relative to a centre of rotation of a the upstream end of the vortex.

Preferably, the method includes the step of establishing the level of liquid in the mixing vessel by using a predetermined level of liquid in an outer vessel, wherein the outer vessel extends above and is in fluid communication with an outlet of the mixing vessel.

In another aspect of the present invention there is provided a method for mixing either a solid or an additional liquid into a liquid, including the steps of:

generating a vortex in said liquid within a mixing vessel;

introducing the solid or the additional liquid to the vortex; and

establishing the level of liquid in the mixing vessel by using a predetermined level of liquid in an outer vessel;

wherein the outer vessel extends above and is in fluid communication with an outlet of the mixing vessel.

The solid or the additional liquid is preferably introduced to the vortex sufficiently close to a perimeter of the vortex such that the occurrence of the solid or the additional liquid falling directly into a central portion of the vortex is minimised.

Preferably, the step of generating a vortex in said liquid within the mixing vessel is achieved by feeding said liquid to the mixing vessel tangentially with respect to the mixing vessel.

Preferably, the method includes the step of recirculating liquid from an outlet of the outer vessel to an inlet of the mixing vessel.

Preferably, the method includes the step of introducing the solid or the additional liquid to the vortex in a stream.

Preferably, the method includes the step of establishing the predetermined level of liquid in the outer vessel by controlling a valve in a liquid inlet leading to the outer vessel.

Preferably, the method includes the step of controlling the vortex such that an inner core of the vortex does not reach the outlet of the mixing vessel.

The invention will now be further described, by way of non-limiting example only, with reference to the accompanying drawings, in which:

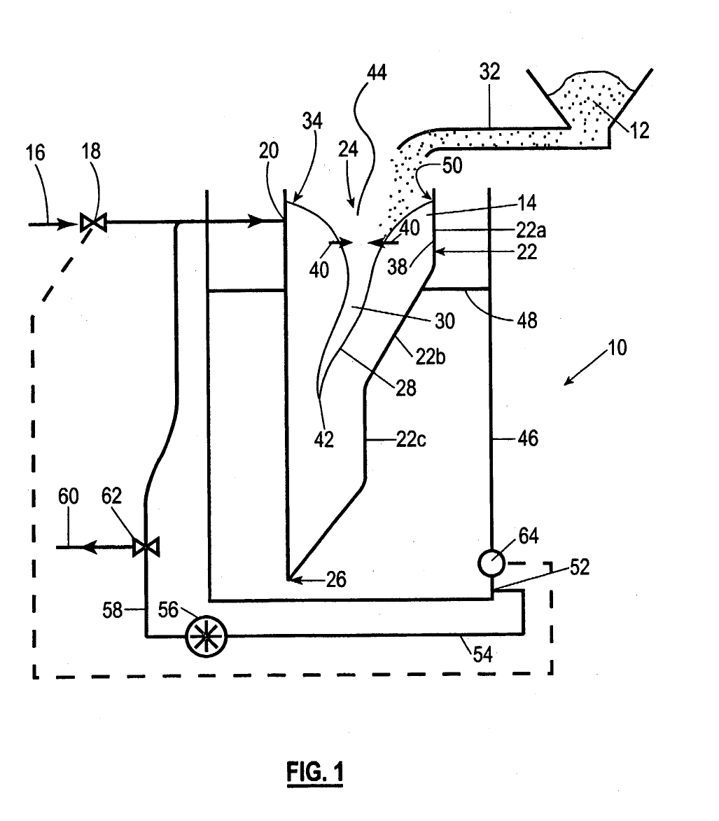

FIG. 1 is a diagrammatic cross-sectional view of a mixer according to an embodiment of the present invention;

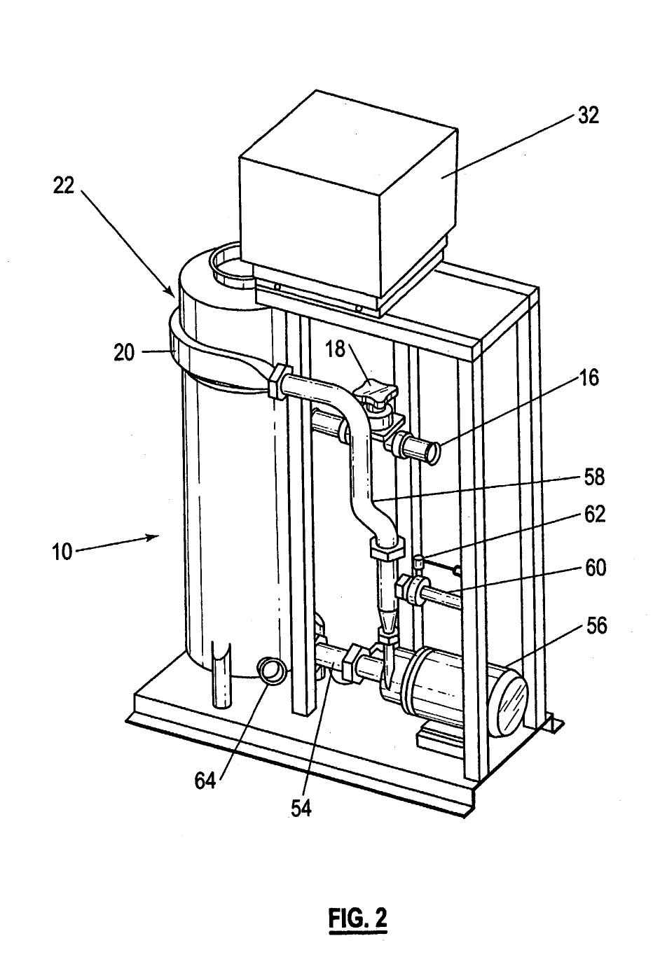

FIG. 2 is a perspective view of the mixer;

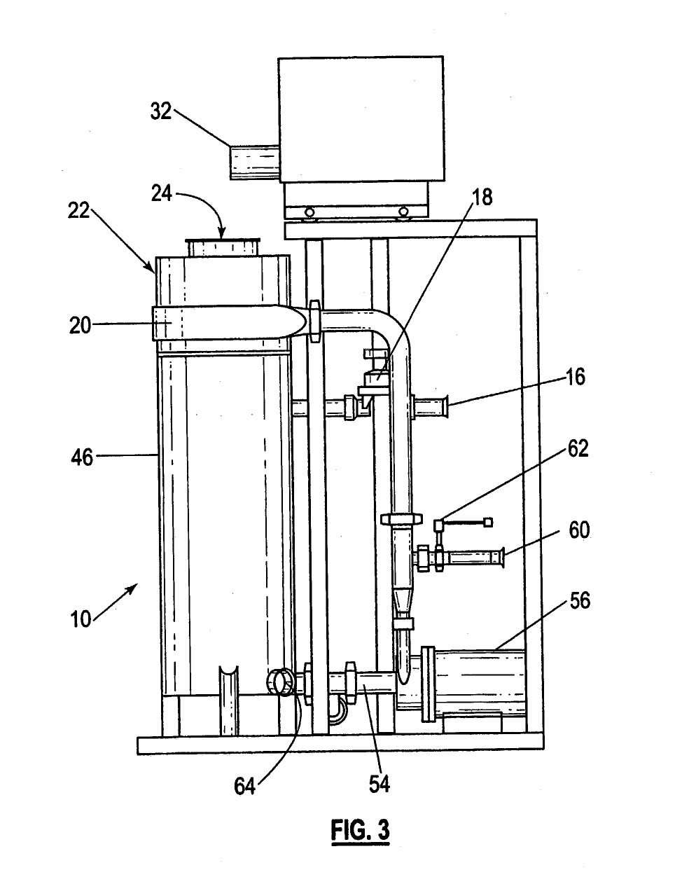

FIG. 3 is a front view of the mixer shown in FIG. 2;

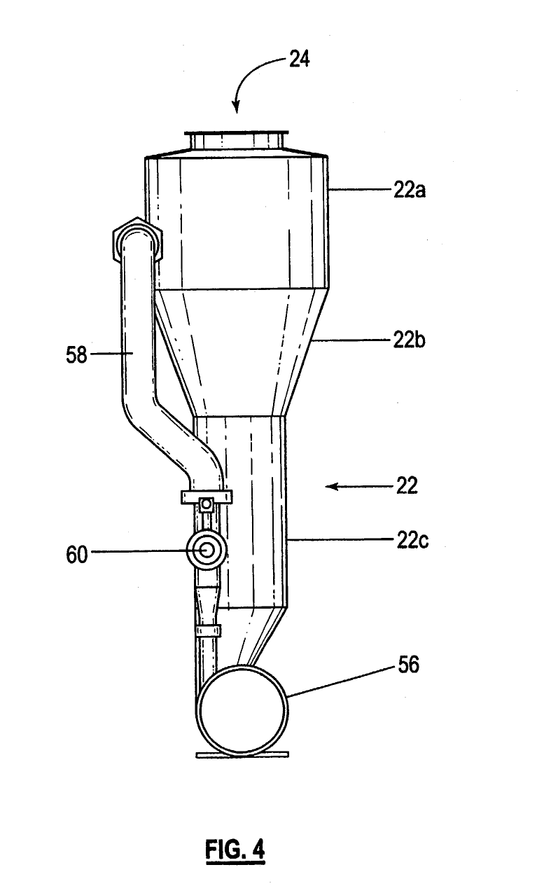

FIG. 4 is a right side view of a mixing vessel of the mixer shown in FIG. 2; and

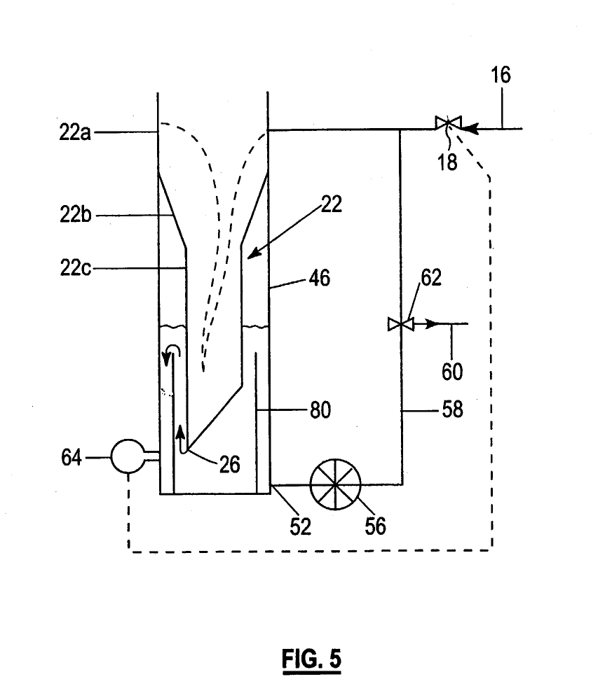

FIG. 5 is a diagrammatic cross-sectional view similar to FIG. 1, but showing a modified arrangement.

A mixer 10 for mixing particulate solid 12 (or additional liquid) with a liquid 14 is shown in the drawings as including a liquid inlet line 16 which is provided with an inlet valve 18 and which is used for introducing liquid to the mixer. The liquid inlet line 16 is in fluid communication with a tangential entry 20 to a mixing vessel 22 of the mixer 10. The mixing vessel 22 is shaped with round cross-sections and is tapered from a large opening 24 at a top end to a smaller discharge outlet 26 at a bottom end. Owing to the tangential entry 20 and the shape of the mixing vessel 22, the liquid 14 (or a solution or suspension) can be fed through the tangential entry 20 to form a vortex 28 within the mixing vessel 22. The velocity and volume flow rate of the liquid 14 being fed through the tangential entry 20 may be varied to control properties of the vortex 28. The depth of the vortex 28 is controlled such that an inner air core 30 of the vortex 28 does not reach the outlet 26 of the mixing vessel 22.

An auger feeder 32 of a commercially available type or other feed device, is positioned above the mixing vessel 22 for dosing the solid 12 (or additional liquid) into the vortex 28 of the mixing vessel 22 at a controlled rate. Preferably, the auger feeder 32 is positioned such that the solid 12 (or additional liquid) is introduced to the vortex 28 near an upper perimeter 34 of the vortex 28 such that the occurrence of the solid 12 (or additional liquid) falling directly into the inner core 30 of the vortex 28 is minimised. Rotation of the vortex 28 causes centrifugal force to act on the solid 12 (or additional liquid), and the centrifugal force causes the solid 12 (or additional liquid) to move outwardly towards an inner surface 38 of the mixing vessel 22. Centrifugal force resulting from the vortex 28 also causes interstitial gas which may be present in the solid 12 (or additional liquid) to travel inwardly (indicated by arrows 40) to the inner air core 30 of the vortex 28, and thus excessive aeration in the resulting product is reduced.

The outlet 26 of the mixing vessel 22 is located eccentrically relative to the mixing vessel 22 such that the axis of rotation of the vortex 28 is bent to prevent solid 12 (or additional liquid) from the auger feeder 32 from being directly applied to the downstream end 42 of the vortex 28. The downstream end 42 is displaced transversely relative to a centre 44 of rotation of the upstream end of the vortex 28.

The outlet 26 of the mixing vessel 22 opens into an outer vessel 46 which surrounds the mixing vessel 22 and which extends above the outlet 26 of the mixing vessel 22. An equilibrium level 48 of liquid in the outer vessel is relatively stable and can be used to determine the level 50 of liquid in the mixing vessel 22. This is particularly advantageous as the level 50 of liquid in the mixing vessel 22 is often difficult to measure directly from the height of the vortex 28 which can be unstable.

An outlet port 52 of the outer vessel 46 is fed into a first pipe 54 which is connected to a mixing pump 56, and the mixing pump 56 feeds into a second pipe 58 which is connected to the tangential entry 20 such that liquid from the pump 56 may be fed back into the mixing vessel 22. The second pipe 58 also has a liquid outlet line 60 which may be opened to varying degrees by way of an outlet valve 62 to allow product to exit from the mixer 10. The mixing pump 56 may be a commercially available unit selected for appropriate flow rate and head requirements.

The product which exits from the liquid outlet line 60 is a substantially homogeneous solution or suspension. The size of the mixing vessel 22 and the flow rate of liquid through the mixer 10 is determined by the particular characteristics of the solid 12 (or additional liquid) and liquid 14 to be mixed.

A sensor 64 located near the bottom of the outer vessel 46 detects the level 48 of liquid in the outer vessel 46 and transmits a signal which is used by the inlet valve 18 to control the level 48 of liquid in the outer vessel 46 by controlling the inlet of further liquid into the mixing vessel 22 from inlet line 16.

In the embodiment illustrated the liquid recirculated by pump 56 and further liquid from inlet line 16 controlled by valve 18 are introduced into the vessel 22 via the same inlet 20. However, they may alternatively be introduced via separate inlets. In another alternative inlet arrangement the inlet line 16 for further liquid controlled by valve 18 may lead directly into the outer vessel 46 or into the pipe 54 upstream of the pump 56. In yet another alternative inlet arrangement, the inlet valve 18 may be incorporated in the pipe 58 downstream of the outlet valve 62. Although as illustrated the pump 56 acts both to recirculate liquid and to discharge liquid via outlet valve 62, in an alternative discharge arrangement discharge can be effected by a separate discharge pump in a discharge line leading from the vessel 46 or from the pipe 54 upstream of the pump 56, with the pump 56 just acting as a recirculation pump.

The mixer 10 can be used continuously or “in-line” rather than in batches. This is achieved by continuously receiving and processing the liquid 14 and the solid 12 (or additional liquid), and by providing a continuous supply of product.

By having the outlet 26 of the mixing vessel located eccentrically relative to the mixing vessel, the above-described mixer has the advantage of alleviating the problem associated with prior art vortex-type mixers of additional liquid or solid accumulating at the downstream end of the vortex.

The provision of the outer vessel 46 in which the liquid level can be accurately controlled by means of the level sensor 64 which controls the inlet valve 18 means that a stable vortex can be maintained irrespective of the outflow rate through the outlet line 60. In this regard, the stability of the vortex within the mixing vessel 22 is dependent on the volume of liquid within the mixing vessel 22, and in practice the stability of the vortex can be adversely affected by relatively small changes in level within the mixing vessel 22; in practice it can be quite difficult to achieve accurate level control just by monitoring the level within the mixing vessel and/or by controlling the input and output flows to achieve a required level for effective and stable operation. It is also to be noted that the recirculation of liquid in conjunction with the level control ensures maintenance of the vortex notwithstanding a large range of different possible outlet flows through the outlet line 60.

In a modified embodiment of the invention shown in FIG. 5, the outlet 26 from the mixing vessel 22 discharges into a cylindrical sleeve 80 mounted within the lower part of the outer vessel 46 and extending to a height below the normal liquid level within the outer vessel as determined by the level sensor 64. The sleeve 80 constitutes a baffle which separates the outlet 26 from the outlet port 52 leading to the pump 56 whereby the liquid flow exiting from the outlet 26 is directed by the sleeve 80 to flow upwardly before being withdrawn through the outlet port 52. This upwards flow enables any air trapped within the liquid to rise to the surface of the liquid within the outer vessel 46 for dispersal rather than being drawn directly into the pump 56 which is not particularly desirable. The flow induced by the sleeve 80 also ensures movement of the general body of liquid within the outer vessel 46 which avoids stagnation of liquid within certain zones of the outer vessel 46 and results in greater consistency of the mixture. The sleeve 80 is provided with a small port at its lower end to facilitate full drainage from the interior of the sleeve at the end of a production run.

Although a cylindrical baffle as provided by the sleeve 80 provides a particularly advantageous flow within the outer vessel, other baffle arrangements which prevent direct passage of liquid from the outlet 26 to the pump 56 by inducing an upwards flow of the liquid to effect removal of any entrapped air could alternatively be provided.

In each of the embodiments described, it will be seen that the mixing vessel 22 has at its upper end a large diameter cylindrical portion 22a which leads via a frusto conical transition zone 22b into a lower cylindrical portion 22c of substantially reduced diameter. This reduction in diameter results in substantially increased centrifugal force within the rotating body of liquid in the lower cylindrical portion 22c due to the increased velocity. As a result of this, heavier particles tend to be forced towards the wall of the mixing vessel 22 thereby ensuring that these particles are effectively wetted, and entrapped air tends to be driven inwardly towards the interior of the vortex for discharge, thereby achieving substantial de-aeration of the mixture.

De-aeration of the mixture to remove air and prevent foaming of the mixture is particularly critical in applications involving the processing of foods or pharmaceuticals in which the presence of air or foaming can be quite detrimental to the overall process.

Although in the embodiments particularly described the mixing vessel 22 is configured to cause the axis of rotation of the vortex to bend, principally by the lateral displacement of the outlet 26, the use of an outer vessel to provide level control within the mixing vessel and a baffle arrangement within the outer vessel to provide further de-aeration of the mixture can also be used to advantage with conventional cyclone mixers in which the outlet from the mixing vessel is centrally placed. It will also be understood that the twin diameter configuration of mixing vessel particularly described could also be applied to advantage to a mixing vessel with a central outlet in order to provide substantially increased centrifugal force within the lower cylindrical portion of reduced diameter.

Although the use of the outer vessel which provides level control within the mixing vessel is particularly advantageous as it facilitates effective control over a wide range of operating parameters, for some situations the outer vessel could be dispensed with and the use of the mixing vessel with laterally offset outlet would still exhibit substantial advantage over conventional mixers.

Instead of mounting at least the lower end portion of the mixing vessel into a liquid-containing outer vessel into which the mixing vessel discharges and which provides a predetermined head of liquid to establish a predetermined level of the vortex, in an alternative configuration the level of the vortex can be established by connecting the interior of the mixing vessel via a liquid feed line to an external liquid tank containing a predetermined head of liquid above the required level of the vortex but below the upper end of the mixing vessel. In this case the external tank can simply act as a balance tank to maintain the level of the vortex at an equilibrium level determined by the head of liquid in the tank, with a separate feed of liquid into the mixing vessel being provided, or alternatively the tank may also act as a feed tank for supply of the entire amount of liquid to the mixing vessel, with the tank then acting both as a feed tank and a balance tank.

Although reference has been made throughout this specification to mixing of a solid with the liquid, it will be understood that the invention is not confined to the mixing of a single solid and the invention is equally applicable to the mixing of two or more different solids. Likewise, reference in this specification to mixing of an additional liquid into the liquid in the mixing vessel is not intended to confine the invention only to the addition of a single additional liquid and two or more different additional liquids can be mixed. When the mixer is used to mix liquids, the or each additional liquid does not necessarily need to be fed into the vortex by a feed device positioned above the mixing vessel as illustrated. Instead, the or each additional liquid can be introduced into the main liquid inlet line leading to the mixing vessel or alternatively it can be fed into the vessel via an inlet positioned in the wall of the vessel below the upper level of the vortex.

In the embodiments described, the vortex is induced by feeding the liquid tangentially into the mixing vessel. In alternative embodiments generation of the vortex within the mixer could be achieved by a mechanical system which induces liquid rotation.

Further modifications are possible within the scope of the invention.

Throughout this specification, unless the context requires otherwise, the word “comprise”, and variations such as “comprises” or “comprising”, will be understood to imply the inclusion of a stated integer or group of integers or steps but not the exclusion of any other integer or group of integers.

1. A mixer for mixing either a solid or an additional liquid into a liquid, the mixer including means for generating a vortex in the liquid within a mixing vessel, and means for introducing the solid or the additional liquid to the vortex, wherein the mixing vessel is shaped such that the solid or additional liquid is unable to be directly applied to a downstream end of the vortex.

2. A mixer according to claim 1, wherein the vessel is shaped so that the downstream end of the vortex is displaced transversely relative to a centre of rotation of the upstream end of the vortex.

3. A mixer according to claim 2, wherein the vessel has an upper cylindrical portion within which the upstream end of the vortex is contained, and a lower cylindrical portion within which the downstream end of the vortex is contained, the axis of the lower cylindrical portion being laterally displaced relative to that of the upper cylindrical portion.

4. A mixer according to claim 3, wherein the lower cylindrical portion of the vessel is of a smaller diameter than the upper cylindrical portion.

5. A mixer according to claim 1 or claim 2, wherein a discharge outlet at a lower end of the mixing vessel is laterally offset relative to the axis of an upper end portion of the vessel containing an upper part of the vortex.

6. A mixing vessel according to any one of claims 1 to 5, wherein the mixing vessel is at least partially within an outer vessel, the outer vessel extending above a discharge outlet of the mixing vessel and being in fluid communication with said discharge outlet such that the level of liquid in the mixing vessel is dependent on the level of liquid in the outer vessel.

7. A mixer according to claim 6, wherein the mixture discharges from the outlet of the mixing vessel into the outer vessel, the mixer further comprising a system to effect withdrawal of the mixture from the outer vessel, said system having pump means and valve means, and means for maintaining a predetermined liquid level within the outer vessel.

8. A mixer according to claim 7, wherein the valve means is controllable to selectively permit recirculation of mixture from the outer vessel into an upstream end portion of the vortex in the mixing vessel.

9. A mixer according to claim 7 or claim 8, wherein the means for maintaining a predetermined liquid level within the outer vessel comprises a valve-controlled liquid feed line for feeding into the vortex the liquid with which the solid or additional liquid is to be mixed, the valve of said liquid feed line being controlled in response to means for sensing the liquid level within the outer vessel.

10. A mixer according to any one of claims 6 to 9, wherein the outer vessel includes baffle means to prevent direct passage of mixture from the discharge outlet of the mixing vessel to an outlet from the outer vessel.

11. A mixer according to claim 10, wherein the baffle means is such as to induce an upwards flow of mixture within the outer vessel whereby air within the mixture discharged from the outlet of the mixing vessel can rise to the surface of the liquid in the outer vessel for release.

12. A mixer according to claim 1, wherein the baffle means comprises a substantially cylindrical sleeve within a lower portion of the outer vessel and surrounding the discharge end portion of the mixing vessel.

13. A mixer according to any one of claims 1 to 5, comprising means for providing a static head of liquid communicating with the liquid in the mixing vessel to maintain a predetermined level of said liquid in the mixing vessel.

14. A mixer for mixing either a solid or an additional liquid into a liquid, the mixer including means for generating a vortex in said liquid within a mixing vessel, and means for introducing the solid or the additional liquid to the vortex, wherein the mixing vessel is at least partially within an outer vessel, the outer vessel extending above a discharge outlet of the mixing vessel and being in fluid communication with said discharge outlet such that the level of liquid in the mixing vessel is dependent on the liquid level within the outer vessel.

15. A mixer according to claim 14, wherein the mixture is discharged from the outlet of the mixing vessel into the outer vessel and is then withdrawn from the outer vessel.

16. A mixer according to claim 15, comprising means for recirculating mixture from the outer vessel to the mixing vessel.

17. A mixer according to any one of claims 14 to 15, comprising liquid level sensing means for sensing the level of liquid within the outer vessel, said sensing means being operative to control inlet of liquid to the mixing vessel for mixing whereby to maintain a predetermined level of mixture within the outer vessel.

18. A mixer according to any one of claims 14 to 17, comprising baffle means within the outer vessel to prevent direct flow of mixture from the discharge outlet of the mixing vessel to an outlet from the outer vessel.

19. A mixer according to claim 18, wherein the baffle means is operative to induce an upwards flow of mixture within the outer vessel whereby air within the mixture discharged from the mixing vessel can rise to the surface of the liquid in the outer vessel for release.

20. A mixer according to any one of claims 14 to 19, wherein the mixing vessel is so shaped that the solid or additional liquid fed to the upstream end of the vortex is unable to be directly applied to a downstream end of the vortex.

21. A mixer according to claim 20, wherein the shaping of the mixing vessel results in the discharge outlet of the vessel being laterally offset relative to the axis of an upper end portion of the mixing vessel containing the upper end portion of the vortex.

22. A mixer according to any one of claims 14 to 21, wherein the mixing vessel has at an upper end portion a large diameter portion which leads via a transition zone into a lower cylindrical portion of substantially reduced diameter.

23. A mixer according to claim 22, wherein the large diameter portion at the upper end of the mixing vessel is cylindrical and the transition zone is of frusto-conical form.

24. A mixer for mixing either a solid or an additional liquid into a liquid, the mixer including means for generating a vortex in said liquid within a mixing vessel, means for introducing the solid or the additional liquid to the vortex, and means for providing a static head of said liquid in the mixing vessel to maintain a predetermined level of the liquid in the mixing vessel.

25. A mixer according to claim 24, wherein the static head of liquid is determined by the liquid head within an outer vessel into which an outlet at the lower end of the mixing vessel discharges.

26. A mixer according to claim 24, wherein the static head is determined by the liquid head in an external liquid vessel coupled to the mixing vessel by a liquid feed line.

27. A mixer for mixing either a solid or an additional liquid into a liquid, the mixer including means for generating a vortex in said liquid within a mixing vessel, and means for introducing the solid or the additional liquid to the vortex, wherein the mixing vessel has at an upper end a large diameter portion which leads via a transition zone into a lower portion of substantially reduced diameter.

28. A mixer according to claim 27, wherein the large diameter portion is cylindrical and the transition zone is at least partially of frusto conical form.

29. A mixer according to claim 27 or claim 28, wherein the axis of the lower cylindrical portion is parallel to and laterally offset from that of the large diameter portion such that the solid or additional liquid fed into the upper end of the vortex in the upper portion of the mixing vessel will not directly contact the lower end of the vortex in the lower cylindrical portion of the mixing vessel.

30. A mixer according to any one of claims 27 to 29, wherein at least a lower end portion of the mixing vessel is mounted within an outer vessel into which an outlet from the mixing vessel discharges, said mixer further comprising means for maintaining a predetermined level of mixture within the outer vessel to provide a static head which maintains the vortex within the mixing vessel at a predetermined level.

31. A mixer according to claim 31, comprising means associated with the outer vessel to facilitate removal of air within the mixture within the outer vessel prior to withdrawal therefrom.

32. A mixer according to claim 31, wherein the said means comprises at least one baffle effective to induce an upwards flow of mixture within the outer vessel whereby air within the mixture can rise to the surface for dispersal prior to withdrawal of the mixture from the outer vessel.

33. A mixer according to claim 1 or claim 2, wherein the vessel has an upstream cylindrical portion in which the upstream end of the vortex is contained and a downstream cylindrical portion in which the downstream end of the vortex is contained, the downstream cylindrical portion being of a smaller diameter than the upper cylindrical portion.

34. A mixer according to claim 33, wherein the upstream and downstream cylindrical portions are co-axial.
